(19) United States
(12) Patent Application Publication
(10) Pub. No.: US 2021/0251375 A1
(43) Pub. Date: Aug. 19, 2021

(54) INTERDENTAL CLEANING TOOL

(71) Applicant: KOBAYASHI PHARMACEUTICAL CO., LTD., Osaka-shi, Osaka (JP)

(72) Inventor: Tasuku KIKKAWA, Ibaraki-shi (JP)

(73) Assignee: KOBAYASHI PHARMACEUTICAL CO., LTD., Osaka-shi, Osaka (JP)

(21) Appl. No.: 17/050,522

(22) PCT Filed: Apr. 26, 2019
(86) PCT No.: PCT/JP2019/017964

§ 371 Date: Oct. 26, 2020

(30) Foreign Application Priority Data
Apr. 27, 2018 (JP) 2018-087029

(51) Int. Cl. A46B 9/04; A46B 3/04

(52) U.S. Cl. CPC A46B 9/045; A46B 2200/108; A46B 3/04

(57) ABSTRACT

The cleaning portion includes a cleaning portion body and a brush portion. The brush portion includes a first brush group and a second brush group. Bristles of the first brush group and the second brush group each have a shape whose a protruding length from the cleaning portion body gradually increases from a top end side to a base end side of the shaft portion. A protruding length from the cleaning portion body of a predetermined numbered one of the second brush group from the top end side to the base end side of the shaft portion is larger than a protruding length from the cleaning portion body of the predetermined numbered one of the bristles of the first brush group from the top end side to the base end side of the shaft portion.

### TECHNICAL FIELD

The present invention relates to an interdental cleaning tool.

### BACKGROUND ART

Conventionally, an interdental cleaning tool far cleaning an interdental space is known. For example, Patent Literature 1 discloses an interdental cleaning tool including a base structure portion made of synthetic resin, and a soft portion made of elastomer. The base structure portion includes a core base structure portion having a shape insertable in an interdental space, and a handling base structure portion having a shape that can be held by fingers. The soft portion includes a covering portion that covers an outer circumferential surface of the core base structure portion, and a plurality of protruding portions each protruding outward from the outer circumferential surface of the covering portion. A plurality of protruding portions forms six protruding portion groups. Each protruding portion group includes a plurality of protruding portions arranged along a direction parallel to an axial direction of the core base structure portion. The protruding portion groups are provided at positions distant from each other in the circumferential direction of the covering portion. A plurality of protruding portions of each protruding portion group has a shape whose the protruding length from the covering portion gradually increases from a top end side to a base end side of the core base structure portion.

### CITATION LIST

### Patent Literature

Patent Literature 1: WO 2013/176297 A

### SUMMARY OF INVENTION

### Problems to be Solved by the Invention

Regarding the interdental cleaning tool as described in Patent Literature 1, there are needs for changing a cleaning effect and feeling while cleaning an interdental space and side surfaces of teeth.

An object of the present invention is to provide an interdental cleaning tool that can change a cleaning effect and feeling while cleaning an interdental space and side surfaces of teeth.

### Solution to Problem

To solve the problem described above, the present invention provides an interdental cleaning tool including a base portion including a shaft portion having a shape insertable in an interdental space, and a cleaning portion that covers at least a portion of the shaft portion and is capable of cleaning an interdental space, where the cleaning portion includes a cleaning portion body that covers at least a portion of the shaft portion, and a brush portion provided on an outer circumferential surface of the cleaning portion body, the brush portion includes a first brush group including a plurality of bristles each having a shape protruding outward from the outer circumferential surface of the cleaning portion body in an intersecting direction that intersects an axial direction of the shaft portion, the plurality of bristles being disposed along a direction parallel to the axial direction, and a second brush group having a shape protruding outward in the intersecting direction at a position on the outer circumferential surface of the cleaning portion body which is distant circumferentially from the first brush group, the second brush group including a plurality of bristles which is disposed along the direction parallel to the axial direction, the bristles of the first brush group have shapes whose protruding lengths from the cleaning portion body gradually increase from a top end side to a base end side of the shaft portion, the bristles of the second brush group have shapes whose protruding lengths from the cleaning portion body gradually increase from the top end side to the base end side of the shaft portion, and a protruding length from the cleaning portion body of a predetermined numbered one of bristles of the second brush group from the top end side to the base end side of the shaft portion is larger than a protruding length from the cleaning portion body of the predetermined numbered one of the bristles of the first brush group from the top end side to the base end side of the shaft portion.

Since the interdental cleaning tool includes the first brush group having the relatively small protruding length from the cleaning portion body and the second brush group having the relatively large protruding length from the cleaning portion body, it is able to make different brush groups contact the interdental space, the gum, and the like while cleaning using the interdental cleaning tool by rotating the base portion about the axis of the shaft portion. Thus, the cleaning effect and feeling can be changed by switching between the interdental cleaning tool being inserted and extracted through the interdental space under a condition where the bristles of the first brush group are in contact with the teeth and the gum, and the interdental cleaning tool being inserted and extracted through the interdental space under a condition where the bristles of the second brush group are in contact with the teeth and the gum.

Furthermore, it is preferable that the brush portion further includes a third brush group having a shape protruding outward in the intersecting direction at a position on the outer circumferential surface of the cleaning portion body which is distant from the second brush group in the circumferential direction opposite to the first brush group with respect to the second brush group, third brush group including a plurality of bristles which is disposed along the direction parallel to the axial direction, and a fourth brush group having a shape protruding outward in the intersecting direction at a position on the outer circumferential surface of the cleaning portion body which is distant from the third brush group in the circumferential direction opposite to the second brush group with respect to the third brush group, the fourth brush group including a plurality of bristles which is disposed along the direction parallel to the axial direction, the bristles of the third brush group have shapes whose protruding lengths from the cleaning portion body gradually increase from the top end side to the base end side of the shaft portion, the bristles of the fourth brush group have shapes whose protruding lengths from the cleaning portion body gradually increase from the top end side to the base end side of the shaft portion, a protruding length from the cleaning portion body of the predetermined numbered one of the bristles of the third brush group from the top end side to the base end side of the shaft portion is smaller than a protruding length from the cleaning portion body of the predetermined numbered one of the bristles of the second brush group from the top end side to the base end side of the shaft portion, and a protruding length from the cleaning portion body of the predetermined numbered one of the bristles of the fourth brush group from the top end side to the base end side of the shaft portion is larger than a protruding length from the cleaning portion body of the predetermined numbered one of the bristles of the third brush group from the top end side to the base end side of the shaft portion.

With the configuration, the bristles having the relatively small protruding lengths from the cleaning portion body and the bristles having the relatively large protruding lengths from the cleaning portion body alternately contact the teeth and the gum by rotating the shaft portion about the axis while cleaning. Thus, the cleaning effect and feeling can be effectively changed.

Furthermore, it is preferable that the brush portion further includes a fifth brush group having a shape protruding outward in the intersecting direction at a position on the outer circumferential surface of the cleaning portion body which is distant from the fourth brush group in the circumferential direction opposite to the third brush group with respect to the fourth brush group, the fifth brush group including a plurality of bristles which is disposed along the direction parallel to the axial direction, and a sixth brush group having a shape protruding outward in the intersecting direction at a position on the circumferential direction opposite to the fourth brush group with respect to the fifth brush group, the six brush group including a plurality of bristles which is disposed along the direction parallel to the axial direction, the bristles of the fifth brush group have shapes whose protruding lengths from the cleaning portion body gradually increase from the top end side to the base end side of the shaft portion, the bristles of the sixth brush group have shapes whose protruding lengths from the cleaning portion body gradually increase from the top end side to the base end side of the shaft portion, a protruding length from the cleaning portion. body of the predetermined numbered one of the bristles of the fifth brush group from the top end side to the base end side of the shaft portion is smaller than a protruding length from the cleaning portion body of the predetermined numbered one of the bristles of the fourth brush group from the top end side to the base end side of the shaft portion, a protruding length from the cleaning portion body of the predetermined numbered one of the bristles of the six brush group from the top end side to the base end side of the shaft portion is larger than a protruding length from the cleaning portion body of the predetermined numbered one of the bristles of the fifth brush group from the top end side to the base end side of the shaft portion, an angle between a direction in which the first brush group protrudes from the cleaning portion body and a direction in which the third brush group protrudes from the cleaning portion body in a normal-to-axis cross-section which is a cross-section normal to the shaft portion, and an angle between a direction in which the third brush group protrudes from the cleaning portion body and a direction in which the fifth brush group protrudes from the cleaning portion body in the normal-to-axis cross-section are from 100 degrees to 140 degrees, inclusive, and an angle between a direction in which the second brush group protrudes from the cleaning portion body and a direction in which the fourth brush group protrudes from the cleaning portion body in the normal-to-axis cross-section, and an angle between a direction in which the fourth brush group protrudes from the cleaning portion body and a direction in which the sixth brush group protrudes from the cleaning portion body in the normal-to-axis cross-section are from 100 degrees to 140 degrees, inclusive.

In the configuration, the space formed by adjacent teeth and gum (so-called triangular space) can be effectively cleaned with the first brush group, the third brush group, and the fifth brush group or with the second brush group, the fourth brush group, and the sixth brush group.

Furthermore, it is preferable that specific numbered bristles of the brush groups from the top end side to the base end side of the shaft portion are spirally arranged on the outer circumferential surface of the cleaning portion body.

With the configuration, the cleaning performance can be improved without deteriorating insertion capability.

Furthermore, the cleaning portion is preferably made of a composite material containing elastomer and a reinforcing material.

Using such a material, the bristles are given a higher rigidity than when the cleaning portion is made only of elastomer, so that the side surfaces of the teeth can be effectively cleaned.

### Advantageous Effects of Invention

According to the present invention as described above, an interdental cleaning tool that can change a cleaning effect and feeling while cleaning an interdental space and side surfaces of teeth can be provided.

### BRIEF DESCRIPTION OF DRAWINGS

FIG. 1 is a front view of an interdental cleaning tool according to an embodiment of the present invention.

FIG. 2 is an enlarged view of a cleaning portion of the interdental cleaning tool illustrated in FIG. 1.

FIG. 3 is a plan view of the interdental cleaning tool illustrated in FIG. 1.

### DESCRIPTION OF EMBODIMENT

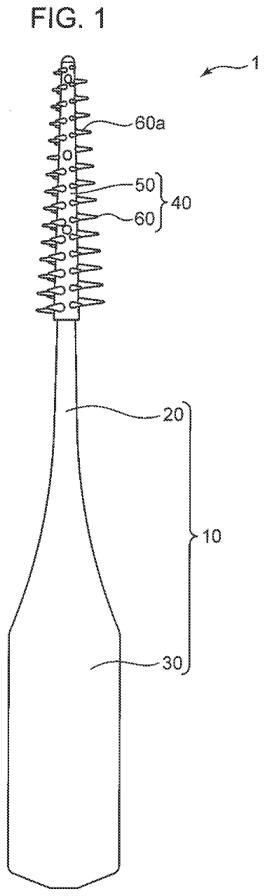

An interdental cleaning tool 1 according to an embodiment of the present invention will be described with reference to FIGS. 1 to 3. As illustrated in FIG. 1, the interdental cleaning tool 1 includes a base portion 10, and a cleaning portion 40.

The base portion 10 is made of a synthetic resin such as polypropylene, polyethylene, ABS, polybutylene terephthalate, polycarbonate, polyethylene terephthalate, polystyrene, and polyacetal. In the embodiment, the base portion 10 is made of polypropylene containing glass fibers by 30% by weight. The base portion 10 includes a shaft portion 20, and a grip portion 30.

The shaft portion 20 has a shape extending in a specific direction (up-and-down direction in FIG. 1) and insertable in an interdental space. The shaft portion 20 has a shape whose a profile of the cross-section of the shaft portion 20 in a plane normal to an axial direction of the shaft portion 20 (the up-and-down direction in FIG. 1) gradually increases from a top end side to a base end side (opposite the top end side) of the shaft portion 20. In the embodiment, the cross-section of the shaft portion 20 in the plane is a circle. That is, in the embodiment, the shaft portion 20 has a form of a column of which outer diameter gradually decreases from a base end portion to a top end portion of the shaft portion 20. The cross-section of the shaft portion 20 may be an oval shape or a polygonal shape.

The grip portion 30 extends in the axial direction of the shaft portion 20 away from the base end portion of the shaft portion 20 and has a shape that can he held by fingers. The grip portion 30 has a flat shape.

The cleaning portion 40 is for cleaning the interdental space and the side surfaces of the teeth. The cleaning portion 40 is made of a resin material having a lower hardness than the base portion 10. Specifically, styrene elastomer is used as the resin material. Other materials, such as silicone olefinic elastomer, and polyester elastomer, may also be used as the resin material. The cleaning portion 40 includes a cleaning portion body 50, and a brush portion 60.

The cleaning portion body 50 covers at least a portion of the shaft portion 20 (portion including the top end portion of the shaft portion 20), The cleaning portion body 50 has a shape of which profile gradually becomes larger from the top end side to the base end side of the shaft portion 20.

The brush portion 60 is provided on the outer circumferential surface of the cleaning portion body 50. The brush portion 60 includes a plurality of bristles 60a each having a shape protruding outward from the outer circumferential surface of the cleaning portion body 50 in an intersecting direction that intersects the axial direction, A plurality of bristles 60a constitute a plurality of (six, in the embodiment) brush groups 61 to 66.

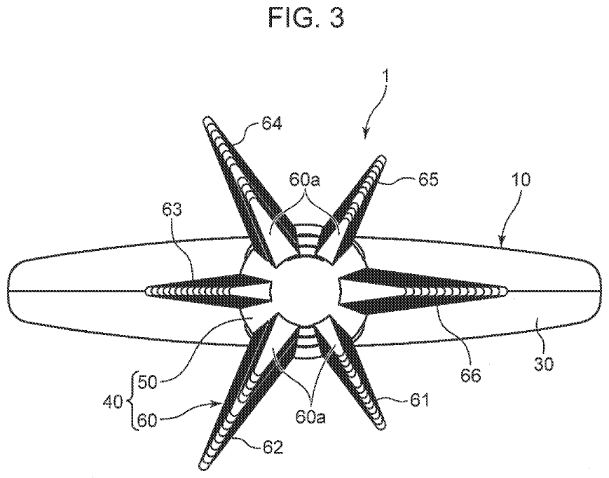

Each of the brush groups 61 to 66 includes a plurality of bristles 60a arranged along a direction parallel to the axial direction. As illustrated in FIG. 3, the second brush group 62 is provided at a position on the outer circumferential surface of the cleaning portion body 50, the position being distant from the first brush group 61 in the circumferential direction of the cleaning portion body 50. The third brush group 63 is provided at a position on the outer circumferential surface of the cleaning portion body 50, the position being distant from the second brush group in the circumferential direction of the cleaning portion body 50 opposite to the first brush group 61 with reference to the second brush group 62. The fourth brush group 64 is provided at a position on the outer circumferential surface of the cleaning portion body 50, the position being distant from the third brush group 63 in the circumferential direction of the cleaning portion body 50 opposite to the second brush group 62 with reference to the third brush group 63. The fifth brush group 65 is provided at a position on the outer circumferential surface of the cleaning portion body 50, the position being distant from the fourth brush group 64 in the circumferential direction of the cleaning portion body 50 opposite to the third brush group 63 with reference to the fourth brush group 64. The sixth brush group 66 is provided at a position on the outer circumferential surface of the cleaning portion body 50, the position being distant from the fifth brush group 65 in the circumferential direction of the cleaning portion body 50 opposite to the fourth brush group 64 with reference to the fifth brush group 65 (is in between the first brush group 61 and the fifth brush group 65 in the circumferential direction).

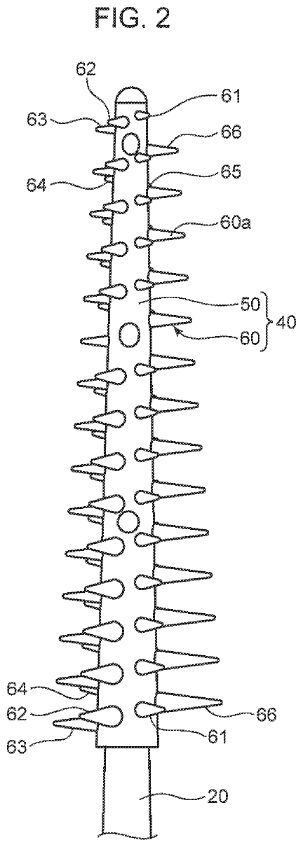

As illustrated in FIG. 2, the bristles 60a have shapes whose the protruding lengths from the cleaning portion body 50 gradually increase from the top end side to the base end side of the shaft portion 20. In the embodiment, the bristles 60a each has a form of a cone.

An angle between a direction in which the first brush group 61 protrudes from the cleaning portion body 50 and a direction in which the third brush group 63 protrudes from the cleaning portion body 50 in a normal-to-axis cross-section which is normal to the shaft portion 20, and an angle between the direction in which the third brush group 63 protrudes from the cleaning portion body 50 and a direction in which the fifth brush group 65 protrudes from the cleaning portion body 50 in the normal-to-axis cross-section are preferably from 100 degrees to 140 degrees, inclusive, more preferably from 110 degrees to 130 degrees, inclusive, and further more preferably 120 degrees, inclusive. An angle between a direction in which the second brush group 62 protrudes from the cleaning portion body 50 and a direction in which the fourth brush group 64 protrudes from the cleaning portion body 50 in the normal-to-axis cross-section, and an angle between the direction in which the fourth brush group 64 protrudes from the cleaning portion body 50 and a direction in which the sixth brush group 66 protrudes from the cleaning portion body 50 in the normal-to-axis cross-section are preferably from 100 degrees to 140 degrees, inclusive, more preferably from 110 degrees to 130 degrees, inclusive, and further more preferably 120 degrees. In the embodiment, the angle between the direction in which the first brush group 61 protrudes from the cleaning portion body 50 and the direction in which the second brush group 62 protrudes from the cleaning portion body 50 in the normal-to-axis cross-section is 60 degrees. The directions in which the brush groups 61 to 66 protrude from. the cleaning portion body 50 respectively mean the directions from the center of the shaft portion 20 toward the respective top ends of the bristles 60a of the brush groups 61 to 66 in the normal-to-axis cross-section.

As illustrated in FIGS. 2 and 3, the protruding length from the cleaning portion body 50 of a predetermined numbered one of the bristles 60a of the second brush group 62 from the top end side to the base end side of the shaft portion 20 (hereinafter referred to as “second protruding length”) is larger than the protruding length from the cleaning portion body 50 of the predetermined numbered one of the bristles 60a of the first brush group 61 from the top end side to the base end side of the shaft portion 20 (hereinafter referred to as “first protruding length”). A ratio of the second protruding length to the first protruding length is preferably from 105% to 300%, inclusive, more preferably from 110% to 200%, inclusive.

The protruding length from the cleaning portion body 50 of the predetermined numbered one of the bristles 60a of the third brush group 63 from the top end side to the base end side of the shaft portion 20 (hereinafter referred to as “third protruding length”) smaller than the protruding length from the cleaning portion body 50 of the predetermined numbered one of the bristles 60a of the second brush group 62 from the top end side to the base end side of the shaft portion 20 (hereinafter referred to as “second protruding length”). A ratio of the third protruding length to the second protruding length is preferably from 33% to 95%, inclusive, more preferably from 50% to 91%, inclusive.

The protruding length from the cleaning portion body 50 of the predetermined numbered one of the bristles 60a of the fourth brush group 64 from the top end side to the base end side of the shaft portion 20 (hereinafter referred to as “fourth protruding size”) is larger than the protruding length from the cleaning portion body 50 of the predetermined numbered one of the bristles 60a of the third brush group 63 from the top end side to the base end side of the shaft portion 20 (hereinafter referred to as “third protruding length”). A ratio of the fourth protruding length to the third protruding length is preferably from 105% to 300%, inclusive, more preferably from 110% to 200%, inclusive.

The protruding length from the cleaning portion body 50 of the predetermined numbered one of the bristles 60a of the fifth brush group 65 from the top end side to the base end side of the shaft portion 20 (hereinafter referred to as “fifth protruding length”) is smaller than the protruding length from the cleaning portion body 50 of the predetermined numbered one of the bristles 60a of the fourth brush group 64 from the top end side to the base end side of the shaft portion 20 (hereinafter referred to as “fourth protruding length”). A ratio of the fifth protruding length to the fourth protruding length is preferably from 33% to 95%, inclusive, more preferably from 50% to 91%, inclusive.

The protruding length from the cleaning portion body 50 of the predetermined numbered one of the bristles 60a of the six brush group 66 from the top end side to the base end side of the shaft portion 20 (hereinafter referred to as “sixth protruding length”) is larger than the protruding length from the cleaning portion body 50 of the predetermined numbered one of the bristles 60a of the fifth brush group 65 from the top end side to the base end side of the shaft portion 20 (hereinafter referred to as “fifth protruding length”). A ratio of the sixth protruding length to the fifth protruding length is preferably from 105% to 300%, inclusive, more preferably from 110% to 200%, inclusive.

Specific numbered bristles 60a of the brush groups 61 to 66 from the top end side to the base end side of the shaft portion 20 are spirally arranged on the outer circumferential surface of the cleaning portion body 50. The protruding length from the cleaning portion body 50 of the specific numbered bristle 60a of the third brush group 63 from the top end side to the base end side of the shaft portion 20 is larger than the protruding length from the cleaning portion body 50 of the specific numbered bristle 60a of the first brush group 61 from the top end side to the base end side of the shaft portion 20. The protruding length from the cleaning portion body 50 of the specific numbered bristle 60a of the fifth brush group 65 from the top end side to the base end side of the shaft portion 20 is larger than the protruding length from the cleaning portion body 50 of the specific numbered bristle 60a of the third brush group 63 from the top end side to the base end side of the shaft portion 20. The protruding length from the cleaning portion body 50 of the specific numbered bristle 60a of the fourth brush group 64 from the top end side to the base end side of the shaft portion 20 is larger than the protruding length from the cleaning portion body 50 of the specific numbered bristle 60a of the second brush group 62 from the top end side to the base end side of the shaft portion 20. The protruding length from the cleaning portion body 50 of the specific numbered bristle 60a of the sixth brush group 66 from the top end side to the base end side of the shaft portion 20 is larger than the protruding length from the cleaning portion body 50 of the specific numbered bristle 60a of the fourth brush group 65 from the top end side to the base end side of the shaft portion 20. The protruding length from the cleaning portion body 50 of the bristle 60a of the first brush group 61 which is situated next to the specific numbered bristle 60a from the top end side to the base end side of the shaft portion 20 is smaller than the protruding length from the cleaning portion body 50 of the specific numbered bristle 60a of the sixth brush group 66 from the top end side to the base end side of the shaft portion 20. As illustrated in FIGS. 1 to 3, the 6^{th} bristle of the first brush group 61 from the top end side to the base end side of the shaft portion 20, the 6^{th} bristle of the second brush group 62 from the top end side to the base end side of the shaft portion 20, the 1^{st} and 6^{th} bristles of the fourth brush group 64 from the top end side to the base end side of the shaft portion 20, and the 1^{st} and 6^{th} bristles of the fifth brush group 65 from the top end side to the base end side of the shaft portion 20 may be omitted.

As described above, the interdental cleaning tool 1 of the present embodiment includes the first brush group 61 having the relatively small protruding length from the cleaning portion body 50, and the second brush group 62 having the relatively large protruding length, so that it is able to make different brush groups contact the interdental space, the gum, and the like while cleaning using the interdental cleaning tool 1 by rotating the base portion 10 about the axis of the shaft portion 20. Thus, the cleaning effect and feeling can be changed by switching between the interdental cleaning tool 1 being inserted and extracted through the interdental space under a condition where the bristles 60a of the first brush group 61 are in contact with the teeth and the gum and the interdental cleaning tool 1 being inserted and extracted through the interdental space under a condition where the bristles 60a of the second brush group 62 are in contact with the teeth and the gum.

Since the interdental cleaning tool 1 includes the third brush group 63, the fourth brush group 64, the fifth brush group 65, and the sixth brush group 66, the bristles 60a having the relatively small protruding lengths from the cleaning portion body 50 and the bristles 60a having the relatively large protruding lengths from the cleaning portion body 50 alternately contact the teeth and the gum by rotating the shaft portion 20 about the axis while cleaning. Thus, the cleaning effect and feeling can effectively be changed.

Furthermore, the angle between the direction in which the first brush group 61 protrudes from the cleaning portion body 50 and the direction in which the third brush group 53 protrudes from the cleaning portion body 50 in the normal-to-axis cross-section, and the angle between the direction in which the third brush group 63 protrudes from the cleaning portion body 50 and the direction in which the fifth brush group 65 protrudes from the cleaning portion body 50 in the normal-to-axis cross-section are 120 degrees, and the angle between the direction in winch the second brush group 62 protrudes from the cleaning portion body 50 and the direction in which the fourth brush group 64 protrudes from the cleaning portion body 50 in the normal-to-axis cross-section, and the angle between the direction in which the fourth brush group 64 protrudes from the cleaning portion body 50 and the direction in which the sixth brush group 66 protrudes from the cleaning portion body 50 in the normal-to-axis cross-section are 120 degrees. Thus, the space formed by adjacent teeth and a gum (so-called a triangular space) can be effectively cleaned with the first brush group 61, the. third brush group 63, and the fifth brush group 65 or with the second brush group 62, the fourth brush group 64, and the sixth brush group 66.

Note that the embodiment disclosed above should be considered as illustrative in all aspects and not by means of limitation. The scope of the present invention is defined by the claims, not by the description on the embodiment described above, and includes all alterations within the scope of the meanings equivalent to the claims and within the scope of the claims.

For example, the number of brush groups included in the brush portion 60 is not limited to six as long as the number is not smaller than two. For example, the number of the brush groups may be eight.

The first brush group 61, the third brush group 63, and the fifth brush group 65 may have the same shape (size). Similarly, the second brush group 62. the fourth brush group 64, and the sixth brush group 66 may have the same shape (size).

Furthermore, the angle between the direction in which the first brush group 61 protrudes from the cleaning portion body 50 and the direction in which the second brush group 62 protrudes from the cleaning portion body 50 in the normal-to-axis cross-section is not limited to 60 degrees.

The bristle 60a may have a shape of a polygonal pyramid or a plate (flat shape).

The cleaning portion 40 may be made of a composite material containing a resin material and a reinforcing material (for example, glass fibers or talc). Using such a material, the bristles 60a are given a higher rigidity than when the cleaning portion 40 is made only of elastomer, so that the side surfaces of the teeth can be effectively cleaned. In this case, the composite material preferably contains the reinforcing material by 1% by weight to 30% by weight, inclusive, more preferably 3% by weight to 20% by weight, inclusive.

### REFERENCE SIGNS

1 interdental cleaning tool

10 base portion

20 shaft portion

30 grip portion

40 cleaning portion

50 cleaning portion body

60 brush portion

61 first brush group

62 second brush group

63 third brush group

64 fourth brush group

65 fifth brush group

66 sixth brush group

1: An interdental cleaning tool comprising:
a base portion including a shaft portion having a shape insertable in an interdental space; and
a cleaning portion that covers at least a portion of the shaft portion and is capable of cleaning an interdental space,
wherein
the cleaning portion includes:
a cleaning portion body that covers at least a portion of the shaft portion, and
a brush portion provided on an outer circumferential surface of the cleaning portion body,
the brush portion includes:
a first brush group including a plurality of bristles each having a shape protruding outward from the outer circumferential surface of the cleaning portion body in an intersect direction that intersects an axial direction of the shaft portion, the plurality of bristles being disposed along a direction parallel to the axial direction, and
a second brush group having a shape protruding outward in the intersecting direction at a position on the outer circumferential surface of the cleaning portion body which is distant circumferentially from the first brush group, the second brush group including a plurality of bristles e which is disposed along the direction parallel to the axial direction,
the bristles of the first brush group have shapes whose protruding lengths from the cleaning portion body gradually increase from a top end side to a base end side of the shaft portion,
the bristles of the second brush group have shapes whose protruding lengths from the cleaning portion body gradually increase from the top end side to the base end side of the shaft portion, and
a protruding length from the cleaning portion body of a predetermined numbered one of the bristles of the second brush group from the top end side to the base end side of the shaft portion is larger than a protruding length from the cleaning portion body of the predetermined numbered one of the bristles of the first brush group from the top end side to the base end side of the shaft portion.

2. The interdental cleaning tool according to claim 1, wherein
the brush portion further includes:
a third brush group having a shape protruding outward in the intersecting direction at a position on the outer circumferential surface of the cleaning portion body which is distant from the second brush group in the circumferential direction opposite to the first brush group with respect to the second brush group, the third brush group including a plurality of bristles which is disposed along the direction parallel to the axial direction, and
a fourth brush group having a shape protruding outward in the intersecting direction at a position on the outer circumferential surface of the cleaning portion body which is distant from the third brush group in the circumferential direction opposite to the second brush group with respect to the third brush group, the fourth brush group including a plurality of bristles which is disposed along the direction parallel to the axial direction,
the bristles of the third brush group have shapes whose protruding lengths from the cleaning portion body gradually increase from the top end side to the base end side of the shaft portion,
the bristles of the fourth brush group have shapes whose protruding lengths from the cleaning portion body gradually increase from the top end side to the base end side of the shaft portion,
a protruding length from the cleaning portion body of the predetermined numbered one of the bristles of the third brush group from the top end side to the base end side of the shaft portion is smaller than a protruding length from the cleaning portion body of the predetermined numbered one of the bristles of the second brush group from the top end side to the base end side of the shaft portion, and
a protruding length from the cleaning portion body of the predetermined numbered one of the bristles of the fourth brush group from the top end side to the base end side of the shaft portion is larger than a protruding length from the cleaning portion body of the predetermined numbered one of the bristles of the third brush group from the top end side to the base end side of the shaft portion.

3. The interdental cleaning tool according to claim 2, wherein
the brush portion further includes:
a fifth brush group having a shape protruding outward in the intersecting direction at a position on the outer circumferential surface of the cleaning portion body which is distant from the fourth brush group in the circumferential direction opposite to the third brush group with respect to the fourth brush group, the fifth brush group including a plurality of bristles which is disposed along the direction parallel to the axial direction, and
a sixth brush group having a shape protruding outward in the intersecting direction at a position on the outer circumferential surface of the cleaning portion body which is distant from the fifth brush group in the circumferential direction opposite to the fourth brush group with respect to the fifth brush group, the sixth brush group including a plurality of bristles which is disposed along the direction parallel to the axial direction,
the bristles of the fifth brush group have shapes whose protruding lengths from the cleaning portion body gradually increase from the top end side to the base end side of the shaft portion,
the bristles of the sixth brush group have shapes whose protruding lengths from the cleaning portion body gradually increase from the top end side to the base end side of the shaft portion,
a protruding length from the cleaning portion body of the predetermined numbered one of the bristles of the fifth brush group from the top end side to the base end side of the shaft portion is smaller than a protruding length from the cleaning portion body of the predetermined numbered one of the bristles of the fourth brush group from the top end side to the base end side of the shaft portion,
a protruding length from the cleaning portion body of the predetermined numbered one of the bristles of the sixth brush group from the top end side to the base end side of the shaft portion is larger than a protruding length from the cleaning portion body of the predetermined numbered one of the bristles of the fifth brush group from the top end side to the base end side of the shaft portion,
an angle between a direction in which the first brush group protrudes from the cleaning portion body and a direction in which the third brush group protrudes from the cleaning portion body in a normal-to-axis cross-section which is a cross-section normal to the shaft portion, and an angle between a direction in which the third brush group protrudes from the cleaning portion body and a direction in which the fifth brush group protrudes from the cleaning portion body in the normal-to-axis cross-section are from 100 degrees to 140 degrees, inclusive, and
an angle between a direction in which the second brush group protrudes from the cleaning portion body and a direction in which the fourth brush group protrudes from the cleaning portion body in the normal-to-axis cross-section, and an angle between a direction in which the fourth brush group protrudes from the cleaning portion body and a direction in which the sixth brush group protrudes from the cleaning portion body in the normal-to-axis cross-section are from 100 degrees to 140 degrees, inclusive.

4. The interdental cleaning tool according to claim 3, wherein
specific numbered bristles of the brush groups from the top end side to the base end side of the shaft portion are spirally arranged on the outer circumferential surface of the cleaning portion body.

5. The interdental cleaning tool according to claim 1, wherein
the cleaning portion is made of a composite material containing elastomer and a reinforcing material.

6. The interdental cleaning tool according to claim 2, wherein
the cleaning portion is made of a composite material containing elastomer and a reinforcing material.

7. The interdental cleaning tool according to claim 3, wherein
the cleaning portion is made of a composite material containing elastomer and a reinforcing material.

8. The interdental cleaning tool according to claim 4, wherein
the cleaning portion is made of a composite material containing elastomer and a reinforcing material.
